(19) United States
(12) Patent Application Publication
(10) Pub. No.: US 2013/0004659 A1
(43) Pub. Date: Jan. 3, 2013

(54) THICK FILM PASTE AND USE THEREOF

(75) Inventors: HOWARD DAVID GLICKSMAN, DURHAM, NC (US); ADELE AMELIA PLISCOTT, BRISTOL (GB)

(73) Assignee: E I DU PONT DE NEMOURS AND COMPANY, Wilmington, DE (US)

(21) Appl. No.: 13/531,769

(22) Filed: Jun. 25, 2012

Related U.S. Application Data
(60) Provisional application No. 61/503,057, filed on Jun. 30, 2011.

(51) Int. Cl. H01B 1/02; B05D 3/02; B05D 5/12

(52) U.S. Cl. 427/125; 252/514

(57) ABSTRACT

A thick film pastes comprising at least one particulate platinum (alloy)/metal oxide composite, an organic vehicle and, as an optional component, at least one particulate platinum (alloy), wherein the total proportion of particulate platinum (alloy)/metal oxide composite plus the optionally present particulate platinum (alloy) in the thick film paste is 84 to 95 wt. %, based on total thick film paste composition.

### FIELD OF THE INVENTION

The present invention is directed to a thick film paste and the use thereof in the production of metallizations which may serve as electrical contacts for electrodes of sensor devices.

### TECHNICAL BACKGROUND OF THE INVENTION

U.S. Pat. No. 6,165,247 discloses a pyrolysis method for the production of platinum metal, platinum alloy or platinum composite particles.

The method for the production of platinum metal particles comprises the steps of: a) generating an aerosol of droplets from a liquid wherein said liquid comprises a platinum metal precursor and wherein said droplets have a size distribution such that at least about 80 weight percent of said droplets have a size of from about 1 μm to about 5 μm; b) moving said droplets in a carrier gas; and c) heating said droplets to remove liquid therefrom and form platinum metal particles.

The method for the production of platinum alloy particles comprises the steps of: a) forming a liquid solution comprising a platinum metal precursor and a second metal precursor; b) generating an aerosol of droplets from said liquid solution; c) moving said droplets in a carrier gas; d) heating said droplets to remove liquid therefrom and form metal alloy particles comprising platinum metal and a second metal.

The method for the production of platinum composite particles comprises the steps of: a) forming a liquid solution comprising a platinum metal precursor and a non-metallic phase precursor; b) generating an aerosol of droplets from said liquid solution; c) moving said droplets in a carrier gas; d) heating said droplets to remove liquid therefrom and form metal composite particles comprising platinum metal and a non-metallic phase. The non-metallic phase may be a metal oxide in particular.

The platinum metal, platinum alloy or platinum composite particles can be used in the manufacture of thick film pastes which can be applied and fired to form electrodes on sensor devices, such as oxygen sensors.

### SUMMARY OF THE INVENTION

The present invention relates to a thick film paste comprising at least one particulate platinum (alloy)/metal oxide composite, an organic vehicle and, as an optional component, at least one particulate platinum (alloy), wherein the total proportion of particulate platinum (alloy)/metal oxide composite plus the optionally present particulate platinum (alloy) in the thick film paste is 84 to 95 wt. %, based on total thick film paste composition.

### DETAILED DESCRIPTION OF THE INVENTION

It has been found that the thick film paste of the present invention allows for the production of metallizations which may serve as electrical contacts (e.g. contact pads) for electrodes of sensor devices, in particular, high temperature gas sensor devices such as exhaust gas sensor devices with improved properties. The improved properties may include improved topography of the finished metallizations as expressed by a smooth appearance with less printing mesh marks, less surface defects like splining, cracks, splits, bubbles and blisters; an improved weldability, in particular improved laser weldability; and an extended service life.

The thick film paste of the present invention comprises at least one particulate platinum (alloy)/metal oxide composite having a weight ratio of elemental platinum plus optionally present alloying metal(s): metal oxide of, for example, 100:1 to 1000:1, wherein the metal oxide is preferably selected from the group consisting of NiO, SiO₂, RuO₂, Rh₂O₃, IrO₂, Cu₂O, CuO,TiO₂, ZrO₂, PbO, SnO₂, CeO₂, Al₂O₃, MnO₂, and MoO₂. Particulate platinum (alloy)/ZrO₂ composites with an elemental platinum plus optionally present alloying metal(s): ZrO2 weight ratio of 100:1 to 200:1 are preferred.

The term “platinum (alloy)” is used herein. It shall mean platinum or a platinum alloy with one or more alloying metals like, for example, ruthenium, rhodium, iridium or, in particular palladium. The platinum alloys comprise, for example, 40 to 99.9 wt. %, preferably 50 to 99.9 wt. % of platinum. Elemental platinum without an alloyed metal is preferred.

Particulate platinum metal (alloy)/metal oxide composites are individual particles that include a platinum (alloy) metal phase and at least one metal oxide phase associated with the platinum (alloy) metal phase. For example, the metal composite particles can include a metal oxide dispersed throughout the platinum (alloy) metal phase or a metal oxide substantially on the outside of the platinum (alloy) metal particulate. Preferred metal oxides to be named in that context comprise NiO, SiO₂, RuO₂, Rh₂O₃, IrO₂, Cu₂O, CuO,TiO₂, ZrO₂, PbO, SnO₂, CeO₂, Al₂O₃, MnO₂, and MoO₂.

Particulate platinum (alloy)/metal oxide composites can in particular be produced by a pyrolysis process as disclosed in the aforementioned patent document U.S. Pat. No. 6,165,247, to which express reference is made herewith.

The at least one particulate platinum (alloy)/metal oxide composite may exhibit an average particle size of, for example, 0.8 to 1.4 μm. Its surface area may be in the range of, for example, 0.4 to 1.0 m²/g as measured by the BET method. It may have a density of, for example, 19 to 22.5 g/ml as measured by Helium pycnometry.

The term “average particle size” is used herein. It shall mean the average particle size (mean particle diameter, d50) determined by means of laser light scattering. Laser light scattering measurements can be carried out making use of a particle size analyzer, for example, a Microtrac S3500 machine.

All statements made in the present description and the claims in relation to average particle sizes relate to average particle sizes of the relevant materials as are present in the thick film paste as supplied to the user or customer.

In an embodiment, the thick film paste of the present invention may comprise at least one particulate platinum (alloy) as an optional component.

The at least one particulate platinum (alloy) may comprise platinum (alloy) particles in various shapes, for example, platinum (alloy) flakes and platinum (alloy) powder including spherical-shaped platinum (alloy) powder and nodular-shaped (irregular-shaped) platinum (alloy) powder, or any combinations thereof. In a preferred embodiment, the particulate platinum (alloy) is platinum (alloy) powder, in particular, spherical-shaped platinum (alloy) powder.

Platinum (alloy) powder, in particular spherical-shaped platinum (alloy) powder, can in particular be produced by a pyrolysis process as disclosed in the aforementioned patent document U.S. Pat. No. 6,165,247, to which express reference is made herewith.

The platinum (alloy) powder may exhibit an average particle size of, for example, 0.8 to 1.4 μm.

The platinum (alloy) powder may comprise crystallites having a size of, for example, 40 to 70 nm.

The total proportion of particulate platinum (alloy)/metal oxide composite plus the optionally present particulate platinum (alloy) in the thick film paste of the present invention is 84 to 95 wt. %, or, in an embodiment, 88 to 93 wt. %, based on total thick film paste composition. In case the thick film paste comprises particulate platinum (alloy), the weight ratio of particulate platinum (alloy)/metal oxide composite: particulate platinum (alloy) may be in the range of, for example, 20:80 to 99.9:0.1. In case the thick film paste composition contains no particulate platinum (alloy), the total proportion of particulate platinum (alloy)/metal oxide composite is 84 to 95 wt. %, or, in an embodiment, 88 to 93 wt. %, based on total thick film paste composition.

In the present description and the claims the term “total thick film paste composition” is used. It shall mean thick film paste as supplied to the user or customer.

In an embodiment, the thick film paste of the present invention may comprise 0.1 to 1 wt. % of at least one particulate metal oxide selected from the group consisting of NiO, SiO₂, RuO₂, Rh₂O₃, IrO₂, Cu₂O, CuO,TiO₂, ZrO₂, PbO, SnO₂, CeO₂, Al₂O₃, MnO₂ and MoO₂. Particulate RuO₂ is preferred. The surface area of the at least one particulate metal oxide may be in the range of, for example, 1 to 25 m²/g, as measured by the BET method.

In another embodiment, the thick film paste of the present invention may comprise 0.1 to 1 wt. % of at least one metal compound capable of forming a metal oxide on firing, the metal oxide being selected from the group consisting of NiO, SiO₂, RuO₂, Rh₂O₃, IrO₂, Cu₂O, CuO,TiO₂, ZrO₂, PbO, SnO₂, CeO₂, Al₂O₃, MnO₂ and MoO₂. Examples of such metal compounds capable of forming a metal oxide on firing comprise in particular corresponding inorganic or metal-organic compounds such as, for example, metal carbonates or metal resinates (metal salts of acidic resins, in particular, resins with carboxyl groups).

Generally, the thick film paste of the present invention comprises no other inorganic constituents than the at least one particulate platinum (alloy)/metal oxide composite and the in each case optional components: at least one particulate platinum (alloy), at least one particulate metal oxide and at least one metal compound capable of forming metal oxide on firing.

The thick film paste of the present invention comprises an organic vehicle. A wide variety of inert viscous materials can be used as organic vehicle. The organic vehicle may be one in which the particulate constituents (particulate platinum (alloy)/metal oxide composite, the optional particulate platinum (alloy) and the optional particulate metal oxide) are dispersible with an adequate degree of stability. The properties, in particular, the rheological properties, of the organic vehicle may be such that they lend good application properties to the thick film paste composition, including: stable dispersion of insoluble solids, appropriate rheology for application, appropriate wettability of the paste solids, a good drying rate, and good firing properties. The organic vehicle used in the thick film paste may be a nonaqueous inert liquid. The organic vehicle may be an organic solvent or preferably an organic solvent mixture; in an embodiment, the organic vehicle may be a solution of organic polymer(s) in organic solvent(s). In an embodiment, the polymer used for this purpose may be ethyl cellulose. Other examples of polymers which may be used alone or in combination include ethylhydroxyethyl cellulose, wood rosin, phenolic resins and poly(meth)acrylates of lower alcohols. Examples of suitable organic solvents comprise ester alcohols and terpenes such as alpha- or beta-terpineol or mixtures thereof with other solvents such as kerosene, dibutylsebacate, diethylene glycol butyl ether, diethylene glycol butyl ether acetate, hexylene glycol, 2,2,4-trimethyl-1,3-pentanediol monoisobutyrate and high boiling alcohols. Various combinations of these and other solvents may be formulated to obtain the viscosity and volatility requirements desired.

The organic vehicle content in the thick film paste may be dependent on the method of applying the thick film paste and the kind of organic vehicle used, and it can vary. In an embodiment, it may be from 5 to 16 wt. %, or, in an embodiment, it may be in the range of 6 to 12 wt. %, based on total thick film paste composition. The organic vehicle content includes organic solvent(s), possible organic polymer(s) and possible organic additive(s).

The organic solvent content in the thick film paste may be in the range of 2 to 10 wt. %, based on total thick film paste composition.

The organic polymer(s) may be present in the organic vehicle in a proportion in the range of 4 to 10 wt. %, based on total thick film paste composition.

The thick film paste of the present invention may comprise one or more organic additives, for example, surfactants, thickeners, rheology modifiers and stabilizers. The organic additive(s) may be part of the organic vehicle. However, it is also possible to add the organic additive(s) separately when preparing the thick film paste. The organic additive(s) may be present in the thick film paste in a total proportion of, for example, 0 to 3 wt. %, based on total thick film paste composition.

The thick film paste of the present invention is a viscous composition, which may be prepared by mechanically mixing the at least one particulate platinum (alloy)/metal oxide composite, the optional particulate platinum (alloy), the optional at least one particulate metal oxide and the optional at least one metal compound capable of forming metal oxide on firing with the organic vehicle. In an embodiment, the manufacturing method power mixing, a dispersion technique that is equivalent to the traditional roll milling, may be used; roll milling or other mixing technique can also be used.

The thick film paste of the present invention can be used as such or may be diluted, for example, by the addition of additional organic solvent(s); accordingly, the weight percentage of all the other constituents of the thick film paste may be decreased.

The application viscosity of the thick film paste of the present invention may be, for example, 100 to 600 Pa·s when measured at a spindle speed of 10 rpm and 25° C. by a utility cup using a Brookfield HBT viscometer and #14 spindle.

The thick film paste of the present invention can be used in the manufacture of metallizations which may serve as electrical contacts for electrodes of sensors, in particular, high temperature gas sensors like exhaust gas sensors. Such sensors may serve to determine gas temperature and/or gas composition with regard to one or more gas components.

Therefore the invention relates also to a method for the manufacture of electrically conductive metallizations of sensors. The method comprises the steps:

(1) applying a thick film paste of the present invention to a sensor substrate which is provided with an electrode,

(2) drying the thick film paste so applied, and

(3) firing the dried thick film paste to form an electrically conductive metallization on the sensor substrate, wherein the metallization is electrically connected with the electrode on the sensor substrate.

Step (1) is performed by applying a thick film paste of the present invention to the sensor substrate which is already provided with an electrode which may take the form of an electrically conductive sub-layer, in particular. The sensor substrate itself is typically a conventional heat-resistant ceramic substrate, for example, an aluminum oxide substrate or a zirconium oxide substrate. The metallization is so applied as to make contact with the electrode. The thick film paste is typically applied in a fired thickness of, for example, 20 to 60 μm. The typical application method is printing, in particular, screen printing.

After application of the thick film paste it is typically dried and fired to form the finished electrically conductive metallization.

Drying may be performed, for example, for a period of 15 to 30 minutes with the sensor substrate reaching a peak temperature in the range of, for example, 100 to 160° C. Drying can be carried out making use of, for example, single or multi-zone belt ovens.

Firing may be performed for a period of, for example, 16 to 24 hours with the sensor substrate reaching a peak temperature in the range of, for example, 1200 to 1350° C. Firing can be carried out making use of a box furnace, for example. Firing may happen in the presence of oxygen, in particular, in the presence of air. During firing the organic substance including non-volatile organic material and the organic portion not evaporated during the possible drying step may be removed, i.e. burned and/or carbonized, in particular, burned. The organic substance removed during firing includes organic solvent(s), possible organic polymer(s) and possible organic additive(s).

The process step sequence (1) to (3) may be repeated several times, for example, 1 to 4 times. This may especially be expedient, when a high fired thickness of the metallization of, for example, 50 to 120 μm is desired.

What is claimed is:

1. A thick film paste comprising at least one particulate platinum (alloy)/metal oxide composite, an organic vehicle and, as an optional component, at least one particulate platinum (alloy), wherein the total proportion of particulate platinum (alloy)/metal oxide composite plus the optionally present particulate platinum (alloy) in the thick film paste is 84 to 95 wt. %, based on total thick film paste composition.

2. The thick film paste of claim 1, wherein the at least one particulate platinum (alloy)/metal oxide composite has a weight ratio of elemental platinum plus optionally present alloying metal(s): metal oxide of 100:1 to 1000:1.

3. The thick film paste of claim 2, wherein the metal oxide of the at least one particulate platinum (alloy)/metal oxide composite is selected from the group consisting of NiO, SiO₂, RuO₂, Rh₂O₃, IrO₂, Cu₂O, CuO,TiO₂, ZrO₂, PbO, SnO₂, CeO₂, Al₂O₃, MnO₂ and MoO₂.

4. The thick film paste of claim 1, wherein the at least one particulate platinum (alloy)/metal oxide composite comprises a particulate platinum (alloy)/ZrO₂ composite with an elemental platinum plus optionally present alloying metal(s): ZrO₂ weight ratio of 100:1 to 200:1.

5. The thick film paste of any one of the preceding claims, wherein the at least one particulate platinum (alloy) powder comprises spherical-shaped platinum (alloy) powder.

6. The thick film paste of any one of the preceding claims, wherein the weight ratio of particulate platinum (alloy)/metal oxide composite:
particulate platinum (alloy) is in the range of 20:80 to 99.9:0.1.

7. The thick film paste of any one of claims 1 to 4 containing no particulate platinum (alloy).

8. The thick film paste of any one of the preceding claims, wherein “platinum (alloy)” is elemental platinum without an alloyed metal.

9. The thick film paste of any one of the preceding claims comprising 0.1 to 1 wt. % of at least one particulate metal oxide selected from the group consisting of NiO, SiO₂, Rh₂O₃, IrO₂, Cu₂O, CuO,TiO₂, ZrO₂, PbO, SnO₂, CeO₂, Al₂O₃, TiO₂, MnO₂ and MoO₂.

10. The thick film paste of any one of claims 1 to 8 comprising 0.1 to 1 wt. % of particulate RuO₂.

11. The thick film paste of any one of the preceding claims comprising 0.1 to 1 wt. % of at least one metal compound capable of forming a metal oxide on firing, the metal oxide being selected from the group consisting of NiO, SiO₂, RuO₂, Rh₂O₃, IrO₂, Cu₂O, CuO,TiO₂, ZrO₂, PbO, SnO₂, CeO₂, Al₂O₃, TiO₂, MnO₂ and MoO₂.

12. The thick film paste of any one of the preceding claims, wherein the organic vehicle content is in the range of 5 to 16 wt. %.

13. A method for the manufacture of electrically conductive metallizations of sensors comprising the steps:
(1) applying a thick film paste of any one of the preceding claims to a sensor substrate which is provided with an electrode,
(2) drying the thick film paste so applied, and
(3) firing the dried thick film paste to form an electrically conductive metallization on the sensor substrate, wherein the metallization is electrically connected with the electrode on the sensor substrate.

14. The method of claim 13, wherein firing is performed for a period of 16 to 24 hours with the sensor substrate reaching a peak temperature in the range of 1200 to 1350° C.

15. The method of claim 13 or 14, wherein the step sequence (1) to (3) is repeated 1 to 4 times.
